(19) United States
(12) Patent Application Publication
(10) Pub. No.: US 2003/0140664 A1
(43) Pub. Date: Jul. 31, 2003

(54) Anti-theft fastener device

(76) Inventor: Edward P. Swertz, Cheektowaga, NY (US)

Correspondence Address: Hodgson Russ LLP, Intellectual Property Law Group, One M & T Plaza Suite 2000, Buffalo, NY, 14203-2391, US

(21) Appl. No.: 10/059,656

(22) Filed: Jan. 29, 2002

(51) Int. Cl. B62H 5/14; B60R 25/00

(52) U.S. Cl. 70/225

(57) ABSTRACT

An improved anti-theft device includes a fastener covered by a circumferential sleeve intended to slip to prevent torque application directly to the fastener, and a corresponding adapter for connecting a tool, such as a socket wrench, to the fastener. An outer face of the fastener comprises an open abutment wall for engagement by an open actuating wall of the adapter, and at least one locating pin communicates between the fastener and adapter. The invention allows unique configurations of the locating pins and walls for giving the adapter the quality of a key. Torque transmission from the adapter to the fastener is more evenly distributed over a greater surface area as compared with prior art anti-theft fasteners and adapters utilizing pins only for torque transmission.

### FIELD OF THE INVENTION

The present invention relates generally to anti-theft fasteners, and more particularly to an improved anti-theft lug nut device.

### BACKGROUND OF THE INVENTION

Conventional wheel lug nuts used to secure wheels and rims on automobiles typically comprise a metallic body that defines an inner face and an outer face connected by an exterior surface. The inner face of a conventional lug nut typically engages the rim of a wheel when tightened on a lug stud of a wheel hub, and the exterior surface is typically configured as a hexagonal structure for engagement by a lug nut wrench or socket.

However, as the popularity of expensive tires and expensive alloy rims has increased, the incidence of theft of these items has also increased. As a result, anti-theft lug nuts, differing from conventional lug nuts, have been introduced to prevent wheel and rim theft. Many of the known anti-theft lug nuts comprise metallic nuts having locks with intricate tumbling mechanisms or ball bearings that require highly specialized or machined keys for unlocking and removing the automobile wheels and rims. Examples of anti-theft lug nuts of this type are shown and described in U.S. Pat. Nos. 1,870,427 and 3,540,245.

Other simpler anti-theft lug nuts, having rounded exterior surfaces extending between their inner and outer faces, are also well known in the art. These lug nuts, which cannot be grasped by conventional wrenches or sockets because of their rounded exterior surfaces, typically have outer faces with pin holes for receiving pins from a corresponding adapter. These adapters, in turn, have structures for interfacing with or being engaged by conventional tools such as a lug wrench or socket. Because torque cannot be readily transmitted to these lug nuts without the corresponding adapter, theft of the wheels and rims is discouraged. An example of an anti-theft wheel lug nut of this type is shown and described in U.S. Pat. No. 3,821,975.

Another anti-theft lug nut device used to prevent the theft of wheels and rims comprises a sleeve that fits about the circumferential exterior surface of a frustoconical lug nut body, whereby removal of the sleeve is prevented when the lug nut is installed. Because this lug nut device allows relative rotation between the sleeve and the lug nut body, engagement of the lug nut body by a conventional lug wrench or socket is prevented and the theft of wheels and rims deterred. Similar to the previously mentioned lug nut, the sleeved, frustoconical anti-theft lug nut has pin holes on its outer face for receiving protruding pins of a corresponding adapter for facilitating lug nut removal. An example of a wheel lug nut of this type is shown and described in U.S. Pat. No. 4,727,702 by the Edward P. Swertz, the Applicant herein.

While the anti-theft wheel lug nuts of the aforementioned designs are highly suitable for preventing and deterring theft, the use of intricate locking assemblies and highly specialized keys is undesirable because these mechanisms can be costly to manufacture. In this regard, anti-theft lug nuts with pin holes in their outer faces for receiving pins from a corresponding adapter are more desirable from manufacturing standpoints.

Often, lug nuts are tightened by auto mechanics using high powered pneumatic wrenches, or the lug nuts are frozen to a mating lug stud as a result of oxidation or rust. One or both of these circumstances can act to make lug nut removal extremely difficult. When this occurs, tremendous torque must be transmitted to the anti-theft lug nut to remove the lug nut. Where an anti-theft lug nut is coupled to a corresponding adapter solely by pins, the pins and pin holes serve to transmit the torque to the ant-theft lug nut. Consequently, if a high level of torque is required, the pins can bend or shear off and become lodged within the pin hole. Also, attempts to remove the stuck lug nuts can damage the pin holes (stripping) such that the adapter can no longer efficiently engage the lug nut without slippage. These problems are highly undesirable because subsequent efforts to remove the anti-theft lug nuts are time consuming and, if undertaken carelessly or in frustration, can lead to substantial damage to expensive wheels and rims.

Thus, what is needed is an improved anti-theft wheel lug nut and adapter that are capable of withstanding the extreme torques required to secure and remove a lug nut.

### SUMMARY OF THE INVENTION

It is, therefore, an object of the present invention to provide a new and improved anti-theft fastener and adapter to reduce the incidence of fastener and/or adapter failure.

It is another object of the present invention to provide an improved anti-theft fastener that is effective in operation and yet inexpensive to manufacture.

It is a further object of the present invention to provide an improved anti-theft fastener and corresponding adapter that are keyed to each other in a manner which also serves in the transmission of torque applied to the adapter.

In view of these objects and in accordance with the present invention, an anti-theft fastener, such as a lug nut, is improved by providing a recessed portion in an outer face of the fastener to define an open abutment wall that is engaged by a complementary open actuating wall on a corresponding adapter. In this way, torque produced during the tightening and/or loosening of the fastener is more efficiently distributed to prevent the incidence of failure of the fastener and adapter. The open abutment wall of the fastener and that of the adapter can be of a unique or substantially unique configuration such that the adapter serves as a key. A sleeve is loosely fitted about an exterior surface of the lug nut and restrained from outwardly directed axial movement relative to the lug nut when the lug nut is installed on a lug stud, thereby preventing torque from being applied to the lug nut regardless of the tool used. The improvement of the present invention is further embodied in a bolt by configuring the bolt head to have an open abutment wall.

### BRIEF DESCRIPTION OF THE DRAWINGS

The nature of the present invention will now be more fully described in the following detailed description of the preferred embodiments taken with the accompanying drawings and figures, in which:

FIG. 1 is a perspective view showing a rim secured to the studs of a wheel hub by conventional lug nuts and by an anti-theft lug nut formed in accordance with a preferred embodiment of the present invention;

FIG. 2 is an exploded view of anti-theft lug nut and corresponding adapter formed in accordance with a preferred embodiment of the present invention;

FIG. 3 is a cross-sectional view taken generally along the lines III-III in FIG. 1;.

FIG. 4 is an exploded view of anti-theft lug nut and corresponding adapter formed in accordance with an alternative embodiment of the present invention;

FIG. 5 is cross-sectional view of an anti-theft bolt formed in accordance with another embodiment of the present invention;

FIG. 6 is a plan view of an outer face of a fastener formed in accordance with a further embodiment of the present invention;

FIG. 7 is a plan view of an outer face of a fastener formed in accordance with a further embodiment of the present invention;

FIG. 8 is a plan view of an outer face of a fastener formed in accordance with a further embodiment of the present invention; and

FIG. 9 is a plan view of an outer face of a fastener formed in accordance with a further embodiment of the present invention.

### DETAILED DESCRIPTION OF THE INVENTION

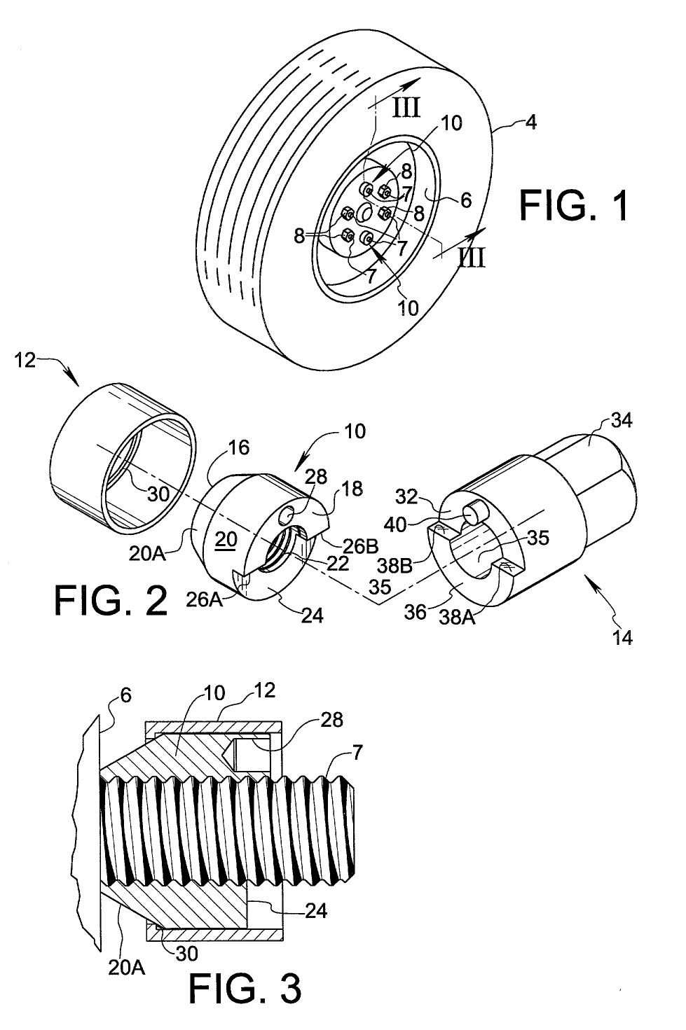

Attention is now directed to FIGS. 1-3 of the drawings showing a preferred embodiment of the present invention. FIG. 1 depicts a wheel 4 and rim 6 secured to the lug studs 7 of an axle wheel hub by a plurality of conventional lug nuts 8 and by at least one anti-theft lug-nut 10 of the present invention. FIG. 2 shows the anti-theft lug nut device of the present invention in greater detail as comprising lug nut 10, a sleeve 12, and a corresponding adapter 14.

Lug nut 10 is generally cylindrical in shape and includes an inner face 16 for engaging the wheel rim 6, an outer face 18, and an exterior surface 20 extending between and connecting inner face 16 and outer face 20. Exterior surface 20 includes a tapered portion 20A adjacent to inner face 16, it being understood that a radial step could be substituted for the smooth taper shown in FIG. 2 to provide a radially reduced portion near inner face 16. Lug nut 10 further includes a threaded bore 22 extending axially therethrough for mating with a lug stud 7. In the present embodiment, outer face 18 includes a recessed portion 24 defining a pair of open abutment walls 26A and 26B separated by threaded bore 22, and a pin hole 28 opens through the non-recessed portion of outer face 18. As used herein, an “open” wall is distinguished from a closed wall such as an inner wall of a pin hole.

Sleeve 12 includes an inner end characterized by a radial lip 30, and is arranged circumferentially about exterior surface 20 of lug nut 10 in a loose fit that allows relative rotation between sleeve 12 and lug nut 10. As can be understood from FIG. 3, lip 30 engages tapered portion 20A such that sleeve 12 is restrained from outwardly directed axial movement relative to lug nut 10 to prevent its removal. It will be realized that a radial step or other radially reducing configuration can be substituted for tapered portion 20A to act as a limit stop encountered by radial lip 30. In this regard, both sleeve 12 and lug nut 10 may be tapered in frustoconical fashion as taught in Applicant's aforementioned U.S. Pat. No. 4,742,702 to prevent the sleeve from being pulled off of the lug nut when the lug nut is mated onto a lug stud 7. Sleeve 12 has an inner diameter that is slightly greater than the outer diameter exterior surface 20 of lug nut 10 to allow sleeve 12 to rotate relative to lug nut 10 if torque is applied to the sleeve, thereby preventing the torque from being transmitted to the lug nut to guarding against unauthorized removal.

Adapter 14 comprises a key face 32 and a tool portion 34. A stud bore 35 opens axially through key face 32 and is sized for accommodating a distal end of lug stud 7. Key face 32 includes a raised portion 36 defining a pair of open actuating walls 38A and 38B separated by stud bore 35 and intended for respectively engaging open abutment walls 26A and 26B of lug nut 10. A locating pin 40 protrudes from the non-raised portion of key face 32 and is sized for fitted slidable receipt by pin hole 28 of lug nut 10. Tool portion 34 is preferably provided near an outer end of adapter 14 opposite key face 32, and is configured for interfacing with a conventional tool for applying torque. In the present embodiment, tool portion 34 has a hexagonal cross-section such that tool portion 34 can be received by a standard socket of a socket wrench, or diametrically opposite flats of tool portion 34 can be engaged by the head of a standard open-ended wrench.

In the embodiment of FIGS. 1-3, key face 32 is complementary to outer face 18 of lug nut 10. As used herein, the term “complementary” refers to the fact that key face 32 can be positioned against outer face 18 such that raised portion 36 of key face 32 is flush against recessed portion 24, the non-raised portion of key face 32 is flush against the non-recessed portion of outer face 18, and open actuating walls 38A and 38B are flush against open abutment walls 26A and 26B.

To use the anti-theft device described above, lug nut 10 with surrounding sleeve 12 is used in place of a conventional lug nut. To tighten the lug nut 10, adapter 14 is positioned by aligning and inserting locating pin 40 within pin hole 28 to bring key face 32 flush against outer face 18 of lug nut 10, interfacing a socket wrench or other compatible torque-applying tool with tool portion 34, and applying torque to rotate the adapter in a tightening direction. Where the tightening direction of rotation is clockwise in FIG. 2, open actuating wall 38A of adapter 14 will be forced against open abutment wall 26A of lug nut 10, thereby transmitting torque to lug nut 10 to tighten lug nut 10 onto lug stud 7. Removal of lug nut 10 is performed in a similar manner using an opposite rotational direction such that torque is transmitted by engagement of open actuating wall 38B with open abutment wall 26B. As will be appreciated, the arrangement of the present invention greatly reduces the magnitude of shear force on one or more locating pins 40, thereby solving a problem encountered with devices of the prior art.

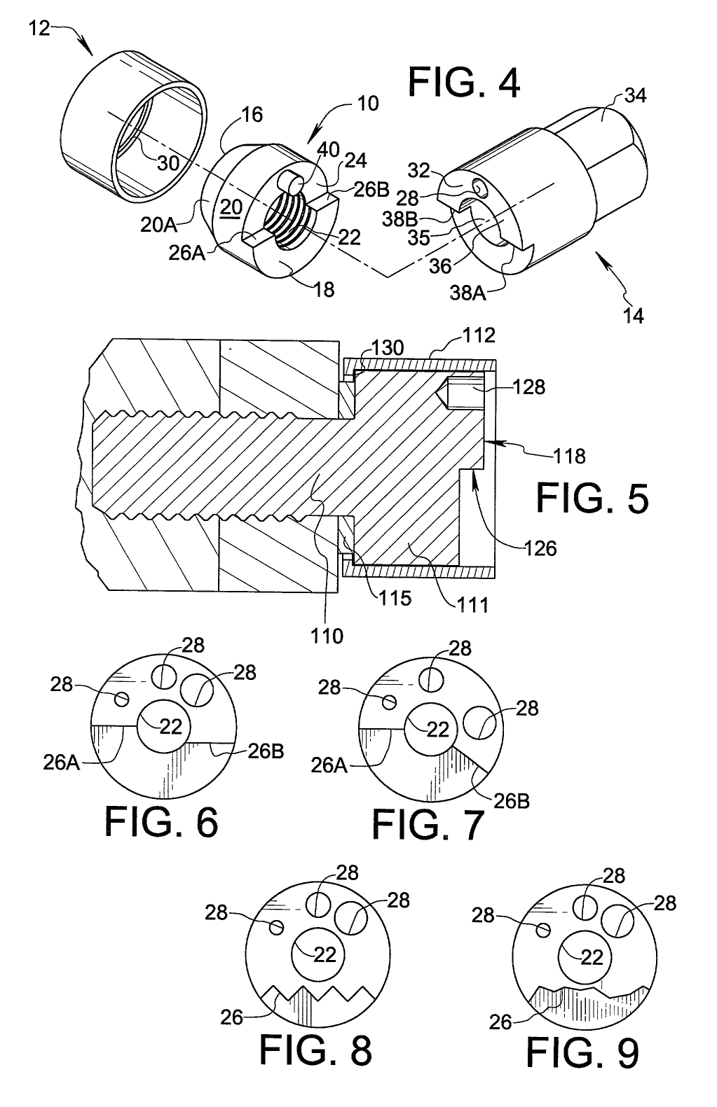

In an alternative embodiment shown in FIG. 4, locating pin 40 protrudes from recessed portion 24 of outer face 18, and pin hole 28 opens through raised portion 36 of key face 32.

FIG. 5 shows a bolt 110 formed in accordance with another embodiment of the present invention. Bolt 110 includes a bolt head 111 having an outer face 118 formed similar to outer face 18 of the first embodiment to define an abutment wall 126 and a pin hole 128. A sleeve 112 analogous to sleeve 12 of the first embodiment fits around bolt head 111, and a spacer 115 provides space for a radial lip 130 of sleeve 112 for limiting outwardly directed axial movement of the sleeve. A corresponding adapter (not shown) mates with bolt 110 for operation.

Notably, the configurations of outer face 18 and key face 32 can be varied to provide unique mating configurations such that a particular adapter 14 is necessary to interface with a particular lug nut 10, whereby the particular adapter acts as a “key” for the lug nut. FIGS. 6-9 provide some further examples of possible configurations of outer face 18 or 118, it being understood that a corresponding adapter would be made to fit each particular configuration. All four examples teach that the number, placement, and diameter of locating pin(s) 40 and pin hole(s) 28 can be varied to provide a unique fit.

Moreover, the examples teach that the location and shape of the open abutment wall(s) on the fastener outer face can be shaped in a distinguishing manner. For example, open abutment walls 26A, 26B can be offset parallel planes as shown in FIG. 6 or they can be angularly spaced by some particular angle about the rotational axis of the fastener as shown in FIG. 7. One continuous open abutment wall 26 can be provided as in FIGS. 8 and 9, and the form of the wall can be random in nature (FIG. 8) or a periodic waveform such as a sinusoidal, square wave or saw tooth form (FIG. 9). Of course, an infinite number of configurations are possible.

What is claimed is:

1. An anti-theft device comprising, in combination:
a fastener having rotational axis, an inner face for facing an item to be secured, an outer face having a recessed portion defining an open abutment wall, and an exterior surface extending between said inner face and said outer face;
a sleeve arranged circumferentially in loose fit about said exterior surface of said fastener to permit relative rotation between said sleeve and said fastener, said sleeve being restrained from outwardly directed axial movement relative to said fastener; and
an adapter including a key face and a tool portion, said key face having a protruding portion defining an open actuating wall for engagement with said open abutment wall of said fastener, and said tool portion being configured for interfacing with a conventional tool for applying torque to said adapter.

2. The anti-theft device of claim 1 wherein said outer face of said fastener comprises a pair of said open abutment walls facing opposite angular directions about said rotational axis of said fastener, and said adapter includes a pair of open actuating walls for respectively engaging said pair of open abutment walls.

3. The anti-theft device of claim 1, wherein said adapter has a locating pin protruding from said key face, and said outer face of said fastener has a pin hole opening therethrough for receiving said pin, whereby said open actuating wall of said adapter is flush against said open abutment wall of said fastener when said pin hole receives said locating pin.

4. The anti-theft device of claim 2, wherein said adapter has a locating pin protruding from said key face, and said outer face of said fastener has a pin hole for receiving said pin, whereby said pair of open actuating walls of said adapter are flush against said pair of open abutment walls of said fastener when said pin hole receives said locating pin.

5. The anti-theft device of claim 1, wherein said fastener has a locating pin protruding from said outer face, and said key face of said adapter has a pin hole for receiving said pin, whereby said open actuating wall of said adapter is flush against said open abutment wall of said fastener when said pin hole receives said locating pin.

6. The anti-theft device of claim 2, wherein said fastener has a locating pin protruding from said outer face, and said key face of said adapter has a pin hole for receiving said pin, whereby said pair of open actuating walls of said adapter are flush against said pair of open abutment walls of said fastener when said pin hole receives said locating pin.

7. The anti-theft device of claim 1, wherein said fastener comprises a nut.

8. The anti-theft device of claim 1, wherein said fastener comprises a bolt.

9. The anti-theft device of claim 1, wherein said outer face of said fastener and said inner face of said adapter are complementary to each other.

10. The anti-theft device of claim 9, wherein said open abutment wall and said actuating wall are each planar.

11. The anti-theft device of claim 9, wherein said open abutment wall and said actuating wall are a periodic waveform.

12. The anti-theft device of claim 11, wherein said open abutment wall and said actuating wall are saw-toothed.

13. The anti-theft device of claim 2, wherein said outer face of said fastener and said inner face of said adapter are complementary to each other.

14. The anti-theft device of claim 13, wherein said pair of open abutment walls are angularly spaced from each other about said rotational axis of said fastener.

15. The anti-theft device of claim 2 wherein each of said pair of open abutment walls is planar, and said pair of open abutment walls are parallel to one another.

16. The anti-theft device of claim 1, wherein said tool portion is of a hexagonal cross-section.

17. The anti-theft device of claim 16, wherein said tool portion is provided adjacent an outer end of said adapter opposite from said key face.
